(19) United States
(12) Patent Application Publication
(10) Pub. No.: US 2007/0180145 A1
(43) Pub. Date: Aug. 2, 2007

(54) Pluggable transceiver module with encryption capability

(75) Inventor: Thomas Scheibe, Oakland, CA (US)

Correspondence Address: LAW OFFICE OF CHARLES E. KRUEGER, P.O. BOX 5607, WALNUT CREEK, CA, 94596-1607, US

(73) Assignee: CISCO TECHNOLOGY, INC. (A California Corporation)

(21) Appl. No.: 11/342,202

(22) Filed: Jan. 27, 2006

(51) Int. Cl. G06F 15/16

(52) U.S. Cl. 709/246

(57) ABSTRACT

A pluggable module for insertion into the port of a network device includes an onboard encryption engine to provide for the use of secure links in networks having legacy switches or routers not including an encryption facility.

### BACKGROUND OF THE INVENTION

Routers and switches (in the following referred to generically as network devices) used in networking systems include slots for accepting modules and cards that allow a user to customize a network device, computer or server for specific environments to satisfy different requirements.

Users have a large investment in previously acquired network devices. When a new network device is introduced it may include features that are not backward compatible with previously acquired legacy network devices coupled to a network or internetwork. One important feature of a network device is encryption of data transmitted over switched (L2) or routed (L3) links. Since these links can be physically intercepted or sniffed, encryption of the data will help secure the link. Encryption can be accomplished utilizing software running on general purpose processors (e.g., CPUs) or specialized IC's (e.g., ASIC and/or FPGA) included in the network device at the end of the encrypted link, or via a separate device (e.g., a firewall or VPN appliance) placed next to the switch/router port or located between two network devices.

There are various problems associated with these solutions for encrypting data on a link.
a) Ease of upgrade: Encryption/decryption tends to be very computing intensive. Software based solutions will offer a path to field upgradeability but cannot provide line-rate performance (e.g., encryption at the speed of 1 Gbps or 10 Gbps as common in todays Ethernet based networks). IC based solutions can offer line-rate encryption/decryption but require a hardware upgrade of the network device.
b) Pay as needed: Upgrades on the network device will burden multiple or all links on that network device, whether encryption is needed or not.
c) Backward compatibility: An upgraded network can only be used with other upgraded switches that have encryption capabilities, so that feature cannot be utilized on links to legacy switches.

Utilizing a separate encryption device, such as a firewall, requires additional rack space. Further, such devices are normally designed for more complex tasks than encrypting data over a link and thus do not provide an efficient solution.

The challenges in the field of data link encryption continue to increase as does the demand for more and better techniques having greater flexibility and adaptability. Therefore, a need has arisen for new methods and systems to preserve capital investment in existing network devices while allowing the use of encryption technology.

### BRIEF DESCRIPTION OF THE DRAWINGS

FIG. 1 is a block diagram of an embodiment of the invention;

FIG. 1A is a more detailed depiction of a module utilizing an embodiment of the invention;

FIG. 2 is a block diagram of the interface between a host and an SFP module implementing an embodiment of the invention;

FIG. 3 is a flow chart depicting steps implemented by an embodiment of the invention

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

In one embodiment of the invention, encryption capability is included in a module that is inserted into a slot of a network device, such as a switch or router. These modules have various form factors and include certain physical and media access layer devices depending on the functions performed by the module. These types of modules include, for example, the GBIC (Gigabit Interface Converter), SFP (Small Form-Factor Pluggable), XFP (10 Gigabit Form-Factor Pluggable), Xenpak, XPAK, and X2 modules, etc.

A first embodiment will be described by way of example, not limitation, implemented in an SFP module. The SFP module is widely utilized in legacy devices and SFP ports represent a large pre-installed base.

The hot-swappable, plug and play, single-port SFP (Small Form-Factor Pluggable) module is used in network devices implementing Gigabit-over-fiber and Gigabit-over-copper applications. The SFP module also offers several significant advantages over its predecessor, the GBIC (Gigabit Interface Converter), including lower cost, lower power, and smaller size. Thus, with the SFP form factor, fiber Gigabit systems may be developed featuring similar port densities as non-pluggable systems using fixed transceivers.

The Small Form-Factor Pluggable (SFP) Transceiver MultiSource Agreements (MSA) document puts forward a specification for the development of optical SFP modules supporting standards such as IEEE 802.3z, the Gigabit Ethernet Standard.

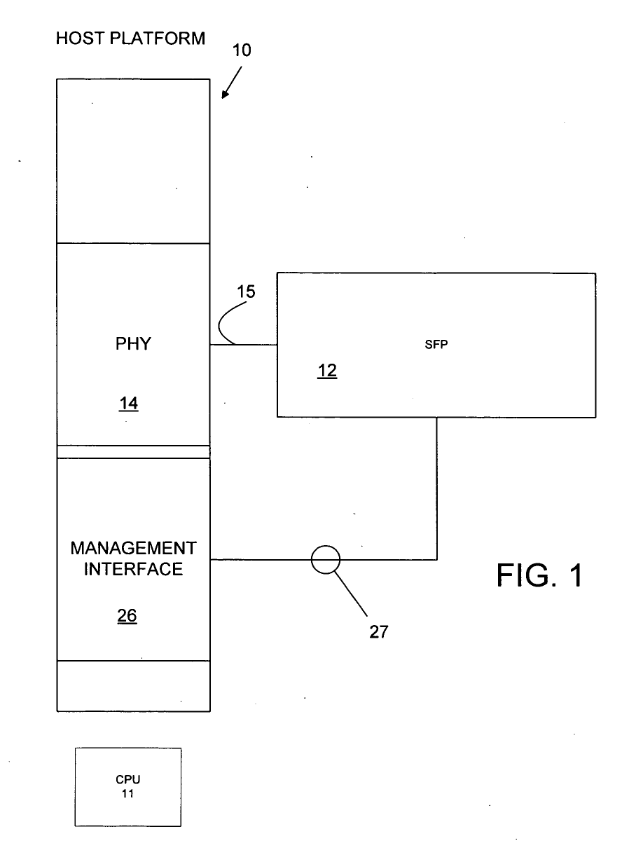

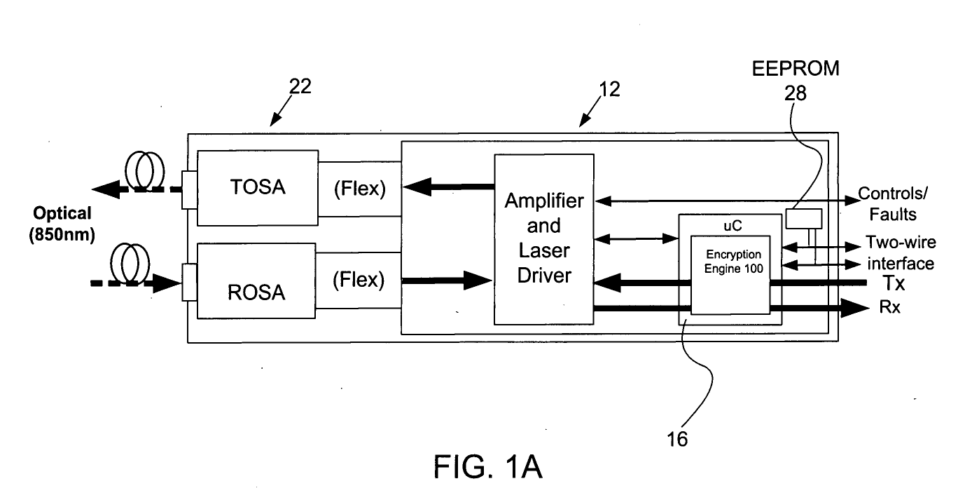

An embodiment of the invention will now be described with reference to FIG. 1 which depicts a Host 10 and an SFP 12. The Host 10 includes a host processor 11 and a PHY module 14. The Host and the SFP are coupled by a data interface 15 (sets of differential data lines for transmit and receive signals) and the management interface 27 (two wire serial interface).

The SFP 12 is depicted in more detail in FIG. 1A, and includes microcontroller ICmodule(s) 16 and optical subassembly 24 having receive a side that includes a ROSA (Receive Optical Subassembly) 24, a transmit side that includes a TOSA (Transmit Optical Subassembly), and an SFP EEPROM 28. The microcontroller IC module 16 is responsible for control of the optical subassembly as well as interaction with the EEPROM 28. In this embodiment, the microcontroller IC module 16 includes an embedded hardware encryption engine 100.

A management serial interface 26 on the host 10 is a 2-wire serial interface, which provides the access to the SFP EEPROM 28 containing the SFP's generic ID data, specific ID data, and other information.

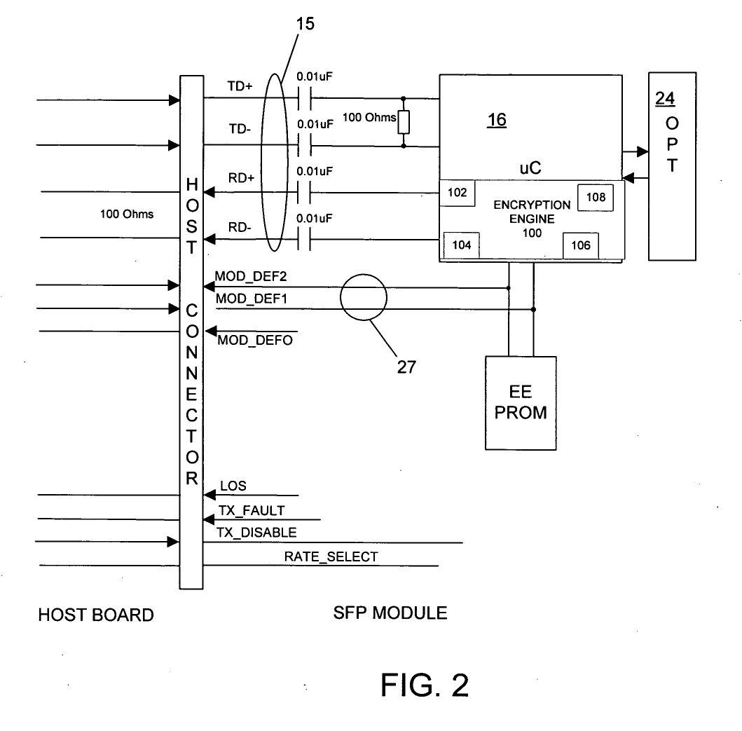

FIG. 2 depicts the connection between the SFP and the host. The 1000Base-X Physical Coding Sub-layer (PCS) supports full-duplex binary transmission at 1.25 Gbps over a differential SERDES interface 15 comprising two copper wire-pairs TD+, TD−, RD+, and RD−. Transmission coding is based on the ANSI Fiber Channel 8B/10B encoding scheme. The MOD_DEF1 and MOD_DEF2 lines form the 2-wire serial interface 27 connecting the host management interface to the EEPROM on the SFP.

The Host/SFP SerDes interface 15 provides the data transfer over the 1.25 Gbps differential interface to the host board and controls and provides configuration functions through the serial management interface 27.

In this embodiment, the encryption engine 100 includes a set of input registers 102, a set of output registers 104, a set of key holding registers 106 for holding a key, and configuration registers 108. During encryption, transmit traffic output from the host PHY is written to the input registers 102 and encrypted by the encryption engine 100 prior to being output on the wire. When encrypted traffic is received on the wire it is written to the input registers of the encryption engine and decrypted prior to being output to the host PHY.

In this embodiment, the 2-wire serial bus 27 is coupled to the key holding registers 106 and the configuration registers 108 of the encryption engine by the microcontroller IC module 16 so that those registers can be programmed utilizing the 2-wire serial management bus 27 depicted in FIG. 2. Alternatively, the configuration registers and key holding registers are located on the EEPROM 28.

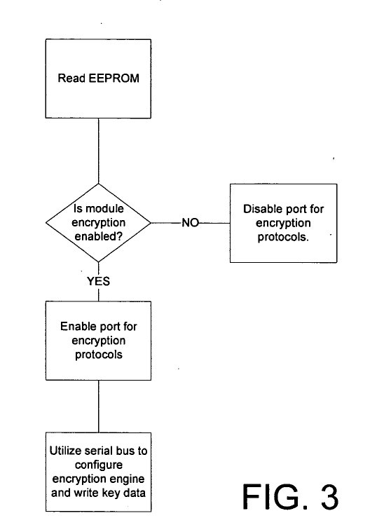

The operation of the embodiment depicted in FIGS. 1, 1A, and 2 will now be described with reference to the flow chart of FIG. 3. Upon start-up or reset, the management interface 26 on the Host 10 reads the EEPROM 28 on the SFP 12 to determine the type of SFP present in the port. The EEPROM 28 of the SFP 12 holds information indicating whether the SFP includes an encryption engine and this information is read by the management engine.

If the SFP includes an encryption engine the host software enables the port so that standard authentication, security associations, and key management protocols, such as ISAKMP, can be enabled for the port. If the SFP does not include an encryption engine then all encryption protocols are disabled for the port.

To implement encryption on the port, the host utilizes the serial bus 27 to configure the encryption engine to provide encrypted data (transmission) or decrypted data (reception) at its output registers. The host can disable the encryption function utilizing the serial bus to configure the encryption engine to provide plaintext data at its output registers.

The host can use the 2-wire serial bus 27 to write key data into the key holding registers prior to enabling encryption or decryption or key data could be transferred over the data interface 15.

Other embodiments of the invention can be implemented in the various types of modules described above. Depending on the form factor, the encryption engine can be integrated into ICs already on the module or included as a separate IC. Some pluggable module have management interfaces with reserved pins that can be utilized to program the encryption engines, and in other cases the key and configuration data can be transmitted as additional data over the serial interface.

The invention has now been described with reference to the preferred embodiments. Alternatives and substitutions will now be apparent to persons of skill in the art. Accordingly, it is not intended to limit the invention except as provided by the appended claims.

What is claimed is:

1. A pluggable module for insertion into the port of a network device comprising:
a host side interface for receiving data and management information from the host;
a media side interface for coupling to media;
a microcontroller for controlling reception and transmission of data;
a storage device, accessible by the host side interface, for holding information indicating whether the pluggable module includes encryption capability; and
an encryption engine, having input and output registers, where, during transmission, the receive registers are coupled to receive transmission data from the physical layer module and the output registers are coupled to provide encrypted transmission data to the media, and where during reception, the receive registers are coupled to receive encrypted received data from the media and the output registers are coupled to provide decrypted received data to the physical layer module.

2. The pluggable module of claim 1 further including:
a key register for holding key data.

3. The pluggable module of claim 2 where:
the host side interface includes a two-wire management bus utilized to query the storage device.

4. The pluggable module of claim 3 where:
the two-wire management bus carries key data to be written to the key register.

5. The pluggable module of claim 1 where the pluggable module is a Small Form-Factor Pluggable Module (SFP).

6. A method for encrypting data over a link, with the link terminating at a pluggable module inserted into a slot on a host, said method comprising:
querying the pluggable module inserted into a slot to determine whether the pluggable module is encryption-enabled; and
transferring key data to the pluggable module, if it is encryption-enabled, to configure the module to encrypt data transmitted on the link and to decrypt data received on the link.

7. The method of claim 6 where:
querying the pluggable module further comprises utilizing a management bus to read a storage device on the module, with the storage device holding an indication of whether the module is encryption enabled; and
transferring key data to the pluggable module further comprises utilizing the management bus to transfer key data to registers on the pluggable module.

8. A system for encrypting data over a link terminating at a pluggable module inserted into the slot of a host network device, said system comprising:
means on the pluggable module for encrypting transmission data prior to transmission over the link and decrypting received data from the link prior to transmission to the host;
means on the pluggable module for indicating whether the pluggable model is encryption enabled;
means on the pluggable module for holding encryption key data;
means on the host for querying the means for indicating to determine whether the pluggable module is encryption enabled; and
means on the host for transferring encryption key data to the means for holding.

9. A network device for encrypting data over a link terminating at a pluggable module inserted into a slot of the network device, said network device comprising:
a microcontroller for controlling reception and transmission of data;
a storage device, holding program code executed by the microcontroller;
an interface for querying the pluggable module to determine whether the pluggable module is encryption-enabled and for reading or writing registers on the pluggable module;
with the microcontroller configured to utilize the interface to query the pluggable module to determine whether the pluggable module is encryption-enabled and to encryption-enable the slot holding the pluggable module if the pluggable module is encryption enable.

10. A system for encrypting data over a link, with the link terminating at a pluggable module inserted into a slot on a host, said system comprising:
means for querying the pluggable module inserted into a slot to determine whether the pluggable module is encryption enabled; and
means for transferring key data to the pluggable module, if it is encryption-enabled, to configure the module to encrypt data transmitted on the link and to decrypt data received on the link.
